(19) United States
(12) Patent Application Publication
(10) Pub. No.: US 2022/0100652 A1
(43) Pub. Date: Mar. 31, 2022

(54) METHOD AND APPARATUS FOR SIMPLIFYING GARBAGE COLLECTION OPERATIONS IN HOST-MANAGED DRIVES

(71) Applicant: ALIBABA GROUP HOLDING LIMITED, George Town (KY)

(72) Inventors: Fei LIU, San Mateo, CA (US); Sheng Qiu, San Mateo, CA (US)

(21) Appl. No.: 17/035,198

(22) Filed: Sep. 28, 2020

(51) Int. Cl. G06F 12/02; G06F 12/0868; G06F 12/0873; G06F 16/22; G06F 16/23; G06F 16/16

(52) U.S. Cl. CPC G06F 12/0253; G06F 12/0246; G06F 12/0292; G06F 12/0868; G06F 16/162; G06F 16/2246; G06F 16/2322; G06F 16/2329; G06F 12/0873

(57) ABSTRACT

The present disclosure provides methods, systems, and non-transitory computer readable media for optimizing garbage collection operations. An exemplary method comprises receiving an update operation on data to be stored in a host-managed drive in a data storage system; inserting the update operation in a local storage of a host of the data storage system; marking one or more obsolete versions of the data in the local storage; and performing, by a translation layer corresponding to the host-managed drive, a garbage collection operation on the host-managed drive, wherein the garbage collection operation removes the one or more obsolete versions of the data marked in the local storage according to the update operation, and the translation layer comprises address mapping information between the host and the host-managed drive.

### TECHNICAL FIELD

The present disclosure generally relates to data storage, and more particularly, to methods, systems, and non-transitory computer readable media for optimizing performance of garbage collections in a data storage system.

### BACKGROUND

All modern-day distributed data storage systems have some form of secondary storage for long-term storage of data. Traditionally, hard disk drives (“HDDs”) were used for this purpose, but computer systems are increasingly turning to solid-state drives (“SSDs”) as their secondary storage unit. While offering significant advantages over HDDs, SSDs have several important design characteristics that must be properly managed. In particular, SSDs may perform garbage collection to enable previously written to physical pages to be reused. Moreover, data storage systems such as distributed data storage systems also need to perform garbage collections in a local storage within the system's host. Garbage collection is very resource intensive, degrading its ability to respond to input/output (“I/O”) commands from the SSD's host system. This in turn reduces overall system performance and increases system cost.

### SUMMARY OF THE DISCLOSURE

Embodiments of the present disclosure provide a method comprising receiving an update operation on data to be stored in a host-managed drive in a data storage system; inserting the update operation in a local storage of a host of the data storage system; marking one or more obsolete versions of the data in the local storage; and performing, by a translation layer corresponding to the host-managed drive, a garbage collection operation on the host-managed drive, wherein the garbage collection operation removes the one or more obsolete versions of the data marked in the local storage according to the update operation, and the translation layer comprises address mapping information between the host and the host-managed drive.

Embodiments of the present disclosure further provide a non-transitory computer readable medium that stores a set of instructions that is executable by at least one processor of a computer system to cause the computer system to perform a method, the method comprising receiving an update operation on data to be stored in a host-managed drive in a data storage system; inserting the update operation in a local storage of a host of the data storage system; marking one or more obsolete versions of the data in the local storage; and performing, by a translation layer corresponding to the host-managed drive, a garbage collection operation on the host-managed drive, wherein the garbage collection operation removes the one or more obsolete versions of the data marked in the local storage according to the update operation, and the translation layer comprises address mapping information between the host and the host-managed drive.

Embodiments of the present disclosure further provide a system, comprising a memory storing a set of instructions; and one or more processors configured to executed the set of instructions to cause the system to perform: receiving an update operation on data to be stored in a host-managed drive in a data storage system; inserting the update operation in a local storage of a host of the data storage system, wherein the host comprises a translation layer corresponding to the host-managed drive; marking one or more obsolete versions of the data in the local storage; and performing, by a translation layer corresponding to the host-managed drive, a garbage collection operation on the host-managed drive, wherein the garbage collection operation removes the one or more obsolete versions of the data marked in the local storage according to the update operation, and the translation layer comprises address mapping information between the host and the host-managed drive.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is an example schematic illustrating a basic layout of an SSD, according to some embodiments of the present disclosure.

FIG. 2 is an illustration of an exemplary internal NAND flash structure of an SSD, according to some embodiments of the present disclosure.

FIG. 3 is an illustration of an exemplary open-channel SSD with host resource utilization, according to some embodiments of the present disclosure.

FIG. 4 is an illustration of an exemplary server of a data storage system, according to some embodiments of the present disclosure.

FIG. 5 is an illustration of an example data storage system implementing a combined garbage collection operation, according to some embodiments of the present disclosure.

FIG. 6 is a flowchart of an example method for performing combined garbage collections, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

Modern day computers are based on the Von Neuman architecture. As such, broadly speaking, the main components of a modern-day computer can be conceptualized as two components: something to process data, called a processing unit, and something to store data, called a primary storage unit. The processing unit (e.g., CPU) fetches instructions to be executed and data to be used from the primary storage unit (e.g., RAM), performs the requested calculations, and writes the data back to the primary storage unit. Thus, data is both fetched from and written to the primary storage unit, in some cases after every instruction cycle. This means that the speed at which the processing unit can read from and write to the primary storage unit can be important to system performance. Should the speed be insufficient, moving data back and form becomes a bottleneck on system performance. This bottleneck is called the Von Neumann bottleneck.

High speed and low latency are factors in choosing an appropriate technology to use in the primary storage unit. Modern day systems typically use DRAM. DRAM can transfer data at dozens of GB/s with latency of only a few nanoseconds. However, in maximizing speed and response time, there can be a tradeoff. DRAM has three drawbacks. DRAM has relatively low density in terms of amount of data stored, in both absolute and relative measures. DRAM has a much lower ratio of data per unit size than other storage technologies and would take up an unwieldy amount of space to meet current data storage needs. DRAM is also significantly more expensive than other storage media on a price per gigabyte basis. Finally, and most importantly, DRAM is volatile, which means it does not retain data if power is lost. Together, these three factors make DRAM not as suitable for long-term storage of data. These same limitations are shared by most other technologies that possess the speeds and latency needed for a primary storage device.

In addition to having a processing unit and a primary storage unit, modern-day computers also have a secondary storage unit. What differentiates primary and secondary storage is that the processing unit has direct access to data in the primary storage unit, but not necessarily the secondary storage unit. Rather, to access data in the secondary storage unit, the data from the second storage unit is first transferred to the primary storage unit. This forms a hierarchy of storage, where data is moved from the secondary storage unit (non-volatile, large capacity, high latency, low bandwidth) to the primary storage unit (volatile, small capacity, low latency, high bandwidth) to make the data available to process. The data is then transferred from the primary storage unit to the processor, perhaps several times, before the data is finally transferred back to the secondary storage unit. Thus, like the link between the processing unit and the primary storage unit, the speed and response time of the link between the primary storage unit and the secondary storage unit are also important factors to the overall system performance. Should its speed and responsiveness prove insufficient, moving data back and forth between the memory unit and secondary storage unit can also become a bottleneck on system performance.

Traditionally, the secondary storage unit in a computer system was HDD. HDDs are electromechanical devices, which store data by manipulating the magnetic field of small portions of a rapidly rotating disk composed of ferromagnetic material. But HDDs have several limitations that make them less favored in modern day systems. In particular, the transfer speeds of HDDs are largely stagnated. The transfer speed of an HDD is largely determined by the speed of the rotating disk, which begins to face physical limitations above a certain number of rotations per second (e.g., the rotating disk experiences mechanical failure and fragments). Having largely reached the current limits of angular velocity sustainable by the rotating disk, HDD speeds have mostly plateaued. However, CPU's processing speed did not face a similar limitation. As the amount of data accessed continued to increase, HDD speeds increasingly became a bottleneck on system performance. This led to the search for and eventually introduction of a new memory storage technology.

The storage technology ultimate chosen was flash memory. Flash storage is composed of circuitry, principally logic gates composed of transistors. Since flash storage stores data via circuitry, flash storage is a solid-state storage technology, a category for storage technology that doesn't have (mechanically) moving components. A solid-state based device has advantages over electromechanical devices such as HDDs, because solid-state devices does not face the physical limitations or increased chances of failure typically imposed by using mechanical movements. Flash storage is faster, more reliable, and more resistant to physical shock. As its cost-per-gigabyte has fallen, flash storage has become increasingly prevalent, being the underlying technology of flash drives, SD cards, the non-volatile storage unit of smartphones and tablets, among others. And in the last decade, flash storage has become increasingly prominent in PCs and servers in the form of SSDs.

SSDs are, in common usage, secondary storage units based on flash technology. Technically referring to any secondary storage unit that does not involve mechanically moving components like HDDs, SSDs are made using flash technology. As such, SSDs do not face the mechanical limitations encountered by HDDs. SSDs have many of the same advantages over HDDs as flash storage such as having significantly higher speeds and much lower latencies. However, SSDs have several special characteristics that can lead to a degradation in system performance if not properly managed. In particular, SSDs must perform a process known as garbage collection before the SSD can overwrite any previously written data. The process of garbage collection can be resource intensive, degrading an SSD's performance.

The need to perform garbage collection is a limitation of the architecture of SSDs. As a basic overview, SSDs are made using floating gate transistors, strung together in strings. Strings are then laid next to each other to form two dimensional matrices of floating gate transistors, referred to as blocks. Running transverse across the strings of a block (so including a part of every string), is a page. Multiple blocks are then joined together to form a plane, and multiple planes are formed together to form a NAND die of the SSD, which is the part of the SSD that permanently stores data. Blocks and pages are typically conceptualized as the building blocks of an SSD, because pages are the smallest unit of data which can be written to and read from, while blocks are the smallest unit of data that can be erased.

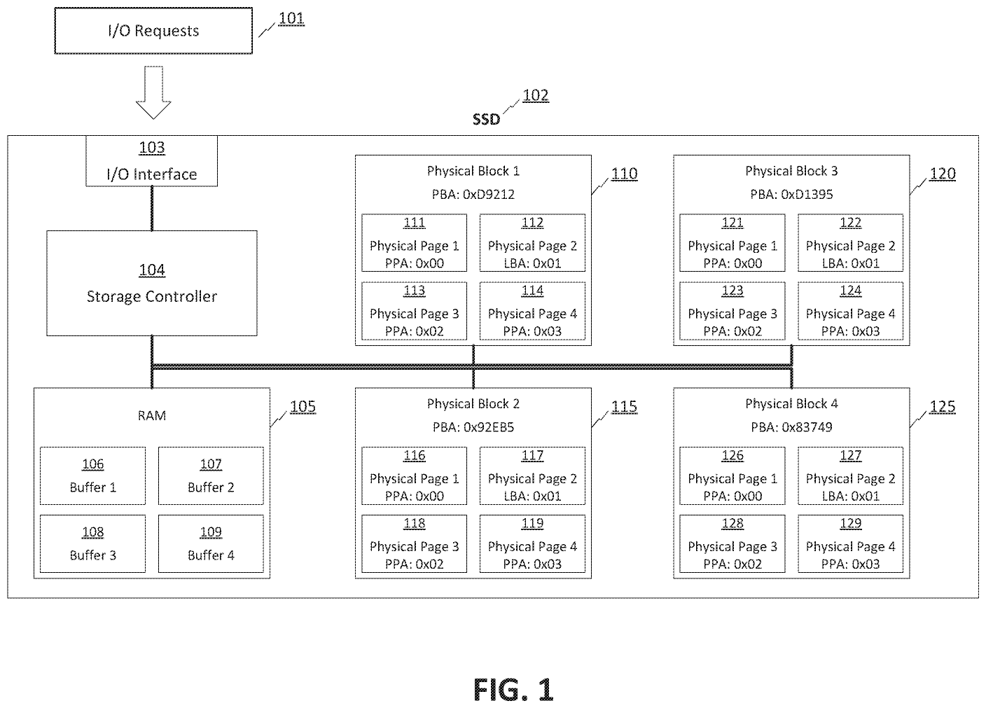

FIG. 1 is an example schematic illustrating a basic layout of an SSD, according to some embodiments of the present disclosure. As shown in FIG. 1, an SSD 102 comprises an I/O interface 103 through which the SSD communicates to a host system via I/O requests 101. Connected to the I/O interface 103 is a storage controller 104, which includes processors that control the functionality of the SSD. Storage controller 104 is connected to RAM 105, which includes multiple buffers, shown in FIG. 1 as buffers 106, 107, 108, and 109. Storage controller 104 and RAM 105 are connected to physical blocks 110, 115, 120, and 125. Each of the physical blocks has a physical block address (“PBA”), which uniquely identifies the physical block. Each of the physical blocks includes physical pages. For example, physical block 110 includes physical pages 111, 112, 113, and 114. Each page also has its own physical page address (“PPA”), which is unique within its block. Together, the physical block address along with the physical page address uniquely identifies a page—analogous to combining a 7-digit phone number with its area code. Omitted from FIG. 1 are planes of blocks. In an actual SSD, a storage controller is connected not to physical blocks, but to planes, each of which is composed of physical blocks. For example, physical blocks 110, 120, 115, and 125 can be on a sample plane, which is connected to storage controller 104.

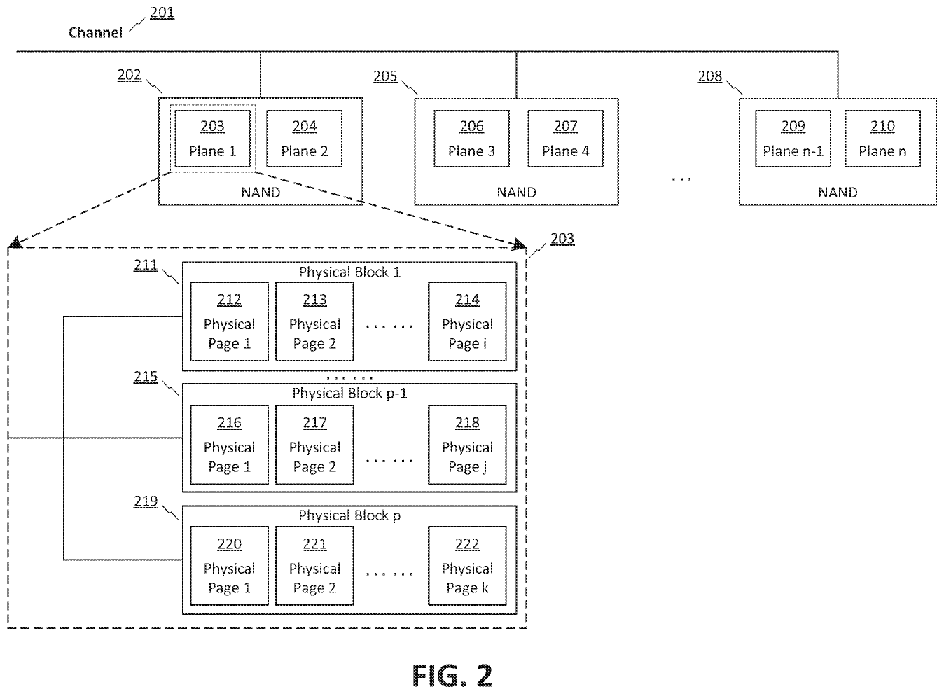

FIG. 2 is an illustration of an exemplary internal NAND flash structure of an SSD, according to some embodiments of the present disclosure. As stated above, a storage controller (e.g., storage controller 104 of FIG. 1) of an SSD is connected with one or more NAND flash integrated circuits (“ICs”), which is where data received by the SSD is ultimately stored. Each NAND IC 202, 205, and 208 typically comprises one or more planes. Using NAND IC 202 as an example, NAND IC 202 comprises planes 203 and 204. As stated above, each plane comprises one or more physical blocks. For example, plane 203 comprises physical blocks 211, 215, and 219. Each physical block comprises one or more physical pages, which, for physical block 211, are physical pages 212, 213, and 214.

An SSD typically stores a single bit in a transistor using the voltage level present (e.g., high or ground) to indicate a 0 or 1. Some SSDs also store more than one bit in a transistor using more voltage levels to indicate more values (e.g., 00, 01, 10, and 11 for two bits). For example, quad level cell (“QLC”) SSDs can store four bits per cell, which can provide substantially higher capacity per drive at a lower cost. Assuming an SSD stores only a single bit for simplicity, an SSD can write a 1 (e.g., can set the voltage of a transistor to high) to a single bit in a page. An SSD cannot write a zero (e.g., cannot set the voltage of a transistor to low) to a single bit in a page. Rather, an SSD can write a zero on a block-level. In other words, to set a bit of a page to zero, an SSD can set every bit of every page within a block to zero. For example, as shown in FIG. 1, to set a bit in physical page 111 to zero, SSD 102 can set every bit of every page (e.g., physical pages 111, 112, 113, and 114) within physical block 110 to zero. By setting every bit to zero, an SSD can ensure that, to write data to a page, the SSD needs to only write a 1 to the bits as dictated by the data to be written, leaving untouched any bits that are set to zero (since they are zeroed out and thus already set to zero). This process of setting every bit of every page in a block to zero to accomplish the task of setting the bits of a single page to zero is known as garbage collection, since what typically causes a page to have non-zero entries is that the page is storing data that is no longer valid (“garbage data”) and that is to be zeroed out (analogous to garbage being “collected”) so that the page can be re-used.

Further complicating the process of garbage collection, however, is that some of the pages inside a block that are to be zeroed out may be storing valid data—in a worst case, all of the pages inside the block except the page needing to be garbage collected are storing valid data, which can cause significant write amplification for the SSD. Write amplification is a phenomenon where the actual amount of information physically written into a storage (e.g., SSD) is a multiple of the logical amount intended to be written. Since the SSD needs to retain valid data, before any of the pages with valid data can be erased, the SSD (usually through its storage controller) can transfer each valid page's data to a new page in a different block. For example, as shown in FIG. 1, physical page 111 may be zeroed out, but other pages (e.g., physical pages 112, 113, and 114) within physical block 110 may be storing valid data. As a result, data in other pages (e.g., physical pages 112, 113, and 114) can be transferred out before physical block 110 is zeroed out.

Transferring the data of each valid page in a block is a resource intensive process, as the SSD's storage controller transfers the content of each valid page to a buffer and then transfers content from the buffer into a new page. Only after the process of transferring the data of each valid page is finished may the SSD then zero out the original page (and every other page in the same block). As a result, in general the process of garbage collection involves reading the content of any valid pages in the same block to a buffer, writing the content in the buffer to a new page in a different block, and then zeroing-out every page in the present block.

Referring back to FIG. 1, SSD 102 can be connected to a host system. For example, SSD 102 can be connected to a host system via I/O interface 103. Drives can be host-managed drives, such as host-based flash translation layer (“FTL”) SSD and host-managed shingled magnetic recording (“SMR”) HDD. A translation layer (e.g., FTL) can map logical block addresses (“LBAs”) on the host side to physical addresses on the SSD. Implementing FTLs in a host is a typical design choice for open-channel SSDs. An open-channel SSD can be an SSD that does not have firmware FTL implemented on the SSD, but instead leaves the management of the physical solid-state storage to the host.

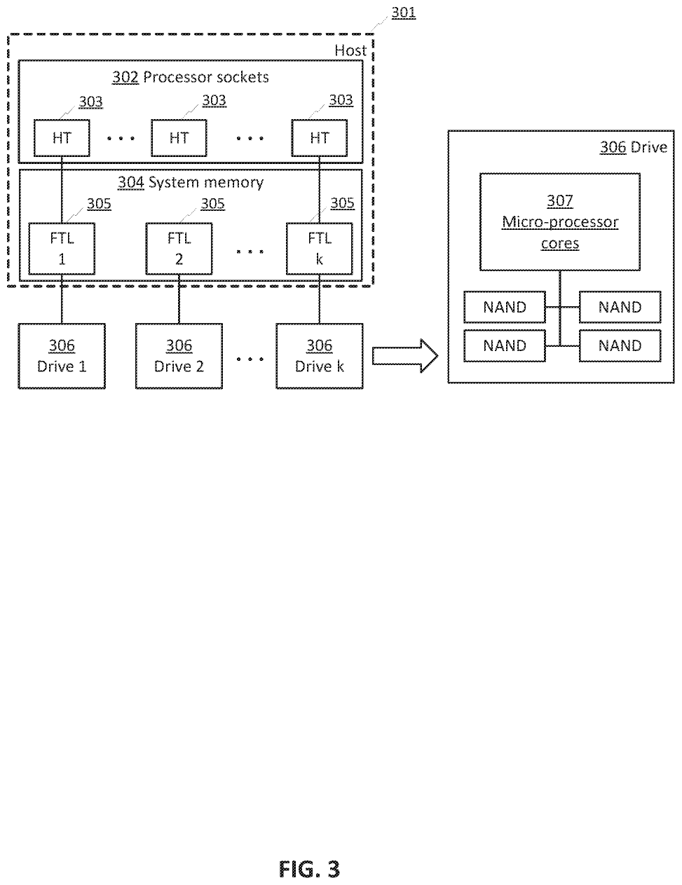

FIG. 3 is an illustration of an exemplary open-channel SSD with host resource utilization, according to some embodiments of the present disclosure. As shown in FIG. 3, host 301 comprises processor sockets 302 and system memory 304. Processor sockets 302 can be configured as CPU sockets. Processor sockets 302 can comprise one or more hyperthreading processes (“HTs”) 303. System memory 304 can comprise one or more FTLs 305. In a server equipped with multiple drives (e.g., drives 306), each drive can launch its own FTL in the host (e.g., host 301). For example, Drive 1 shown in FIG. 3 can launch its own FTL 1 as a part of host 301 and claim a part of system memory 304. Meanwhile, the SSD shown in FIG. 3 (e.g., drive 306) still executes simplified firmware for tasks such as NAND media management and error handling. As a result, microprocessor cores in the SSD (e.g., micro-processor cores 307) are still needed.

As shown in FIG. 3, host 301 can be a host for a distributed data storage system. A distributed data storage system is a data storage infrastructure that can split data across multiple physical servers or data centers. Data is typically stored in distributed data storage systems in a replicated fashion. The distributed data storage system can provide mechanisms for data synchronization and coordination between different nodes. As a result, distributed data storage systems are highly scalable, since a new storage node (e.g., physical servers, data centers, etc.) can be added into the distributed data storage system with relative ease. The distributed data storage systems have become a basis for many massively scalable cloud storage systems.

In distributed data storage systems, key-value stores are a popular form of data storage engines. Key-value stores is a data structure designed for storing, retrieving, and managing data in a form of associative arrays, and is more commonly known as a dictionary or a hash table. Key-value stores include a collection of objects or records, which in turn have many different fields within them, each including data. These records are stored and retrieved using a key that uniquely identifies the record. The key is used to quickly find a requested data within the data storage systems.

In addition to data storage, the key-value stores can also be used to map LBA to PBA in the FTL. For example, in a key-value FTL (“KVFTL”), LBAs can be implemented as keys and PBAs can be implemented as values. As a result, systems using KVFTL can use any key-value structures to quickly locate data's PBA on the SSD through the data's LBA.

Rooted tree structures, such as the log-structured merge trees (“LSM trees”), is standard for key-value stores. The rooted tree structures do not perform update operations on data records directly in place. Instead, the rooted tree structures insert updates into the key-value stores as a new version of the same key. For example, when a delete operation is performed, the rooted tree structures can insert delete operations as updates with keys and a delete marker. New updates can render old versions of the same key obsolete. This process is similar to the write process on SSDs, since the data is not updated directly in place. However, one difference is that the update operations for the key-value stores in the host system is directed to the distributed data storage, and the write operations on SSDs are directed to the physical write operation on the SSDs.

Due to the nature of the rooted tree structures, the updates of the same key can naturally fall into locations that are close with each other. When a read operation is performed, the rooted tree structures can trace from the youngest version to the oldest version of the key and return version(s) that are still valid.

Over time, data volume of the data storage systems grow indefinitely. To prevent the local storage on the data storage systems from running out of space, a garbage collection process can be performed periodically on a local storage of a host system (e.g., host 301 of FIG. 3). One example of the garbage collection process performed on the local storage is a compaction process. The compaction process is a background process that reads some or all data stores in the local storage, and then combines them into one or more new data stores using a sorting process (e.g., merge sort). The compaction process brings different versions of the same key together during the sorting process and discards obsolete versions. The compaction process then writes valid versions of each key into a new data store.

The garbage collection process is performed periodically on the local storage of the data storage system to remove obsolete records and keep the data storage system from running out of space. In addition, the sorting process within the garbage collection process can realign data to improve read performance. Therefore, the garbage collection process repeatedly reads and rewrites data that has already been written to a physical storage, causing write amplification. For example, each time a garbage collection process is performed, a record is read and rewritten at least once. Therefore, if the garbage collection process is performed 100 times per hour, the record would be read and rewritten at least 100 times, even if the client may have never updated the record in the same time period. As a result, the constant reads and rewrites performed by the garbage collection process can consume a vast majority of an input/output (“I/O”) bandwidth provided by the physical storage, which competes with the client's operations and greatly reduces the throughput of the entire system.

There are a number of issues with the open-channel SSDs shown in FIG. 3. First, host 301 performs garbage collection processes (e.g., compaction processes) to remove obsolete data records in the local storage, which can cause significant write amplifications on the data storage system. Second, SSDs (e.g., drive 306 of FIG. 3) also perform garbage collections on the internally stored data, which further causes significant write amplifications. As a result, the data storage system can be strained by at least two sets of garbage collection processes performed on the host and on the SSDs.

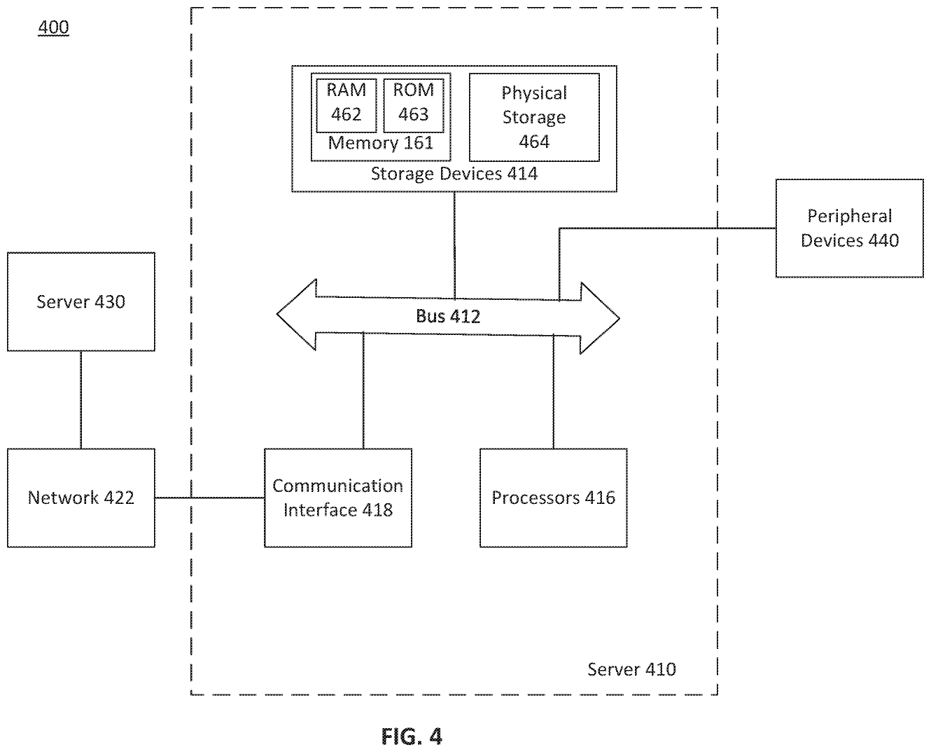

Embodiments of the present disclosure provide novel methods and systems to combine the garbage collection operations to mitigate the issues discussed above. The combined garbage collection operations can be performed by a server of a data storage system or a distributed data storage system. FIG. 4 is an illustration of an exemplary server of a data storage system, according to some embodiments of the present disclosure. As shown in FIG. 4, data storage system 400 comprises server 410. Server 410 comprises a bus 412 or other communication mechanism for communicating information, and one or more processors 416 communicatively coupled with bus 412 for processing information. Processors 416 can be, for example, one or more microprocessors.

Server 410 can transmit data to or communicate with another server 430 through a network 422. In some embodiments, servers 410 and 430 are similar to host 301 of FIG. 3. Network 422 can be a local network, an internet service provider, internet, or any combination thereof. Communication interface 418 of server 410 is connected to network 422. In addition, server 410 can be coupled via bus 412 to peripheral devices 440, which comprises displays (e.g., cathode ray tube (“CRT”), liquid crystal display (“LCD”), touch screen, etc.) and input devices (e.g., keyboard, mouse, soft keypad, etc.).

Server 410 can be implemented using customized hard-wired logic, one or more ASICs or FPGAs, firmware, or program logic that in combination with the server causes server 410 to be a special-purpose machine.

Server 410 further comprises storage devices 414, which may include memory 461 and physical storage 464 (e.g., hard drive, solid-state drive, etc.). Memory 461 may include random access memory (“RAM”) 462 and read only memory (“ROM”) 463. Storage devices 414 can be communicatively coupled with processors 416 via bus 412. Storage devices 414 may include a main memory, which can be used for storing temporary variables or other intermediate information during execution of instructions to be executed by processors 416. Such instructions, after being stored in non-transitory storage media accessible to processors 416, render server 410 into a special-purpose machine that is customized to perform operations specified in the instructions. The term “non-transitory media” as used herein refers to any non-transitory media storing data or instructions that cause a machine to operate in a specific fashion. Such non-transitory media can comprise non-volatile media and/or volatile media. Non-transitory media include, for example, optical or magnetic disks, dynamic memory, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, flash memory, register, cache, any other memory chip or cartridge, and networked versions of the same.

Various forms of media can be involved in carrying one or more sequences of one or more instructions to processors 416 for execution. For example, the instructions can initially be carried out on a magnetic disk or solid-state drive of a remote computer. The remote computer can load the instructions into its dynamic memory and send the instructions over a telephone line using a modem. A modem local to server 410 can receive the data on the telephone line and use an infra-red transmitter to convert the data to an infra-red signal. An infra-red detector can receive the data carried in the infra-red signal and appropriate circuitry can place the data on bus 412. Bus 412 carries the data to the main memory within storage devices 414, from which processors 416 retrieves and executes the instructions.

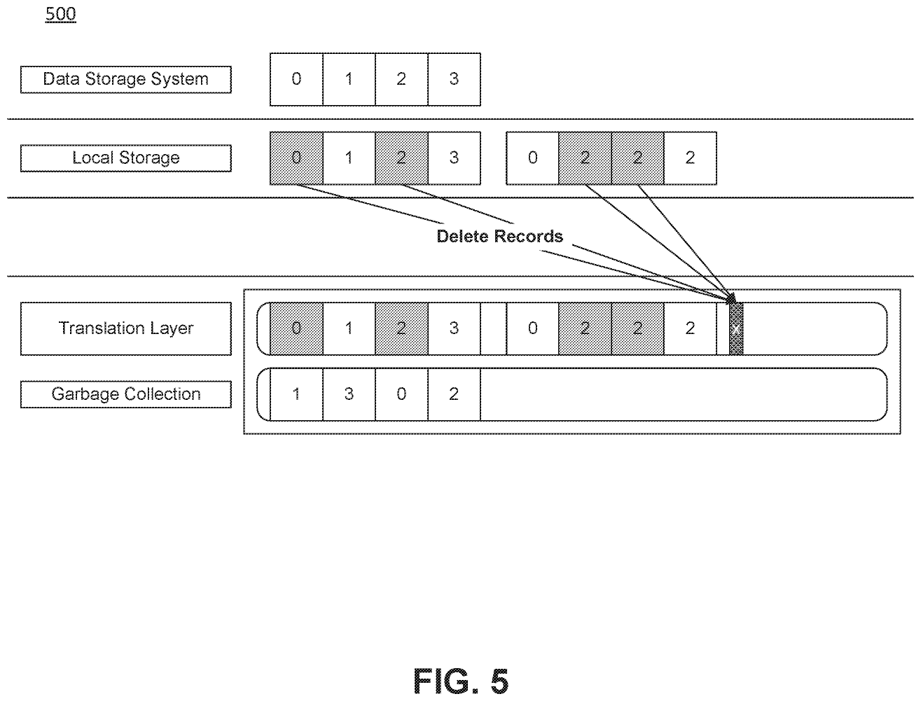

FIG. 5 is an illustration of an example data storage system implementing a combined garbage collection operation, according to some embodiments of the present disclosure. It is appreciated that data storage system 500 shown in FIG. 5 can be implemented by host 301 shown in FIG. 3 or data storage system 400 shown in FIG. 4. In some embodiments, data storage system 500 is a distributed data storage system.

As shown in FIG. 5, data storage system 500 can comprise four sets of data, namely data sets 0-3. In some embodiments, these sets of data can be stored according to key-value stores or rooted tree structures for key-value stores. Over time, each set of data can be updated (e.g., data can be added, modified, or deleted). As discussed previously, when data is updated, the update operations (e.g., modifying operation, deleting operation, etc.) may not be performed directly on the copy of the data stored in a local storage (e.g., storage devices 414) on a host. Instead, the operations can be inserted into the storage as a new version. For example, as shown in FIG. 5, data set 0 is updated once, and data set 2 is updated three times. The newer versions of data sets 0 and 2 are appended to the local storage.

When a new version of the data is inserted into the local storage, the older versions can be considered as obsolete. In a traditional design, a compaction process or a garbage collection process is performed by the data storage system to collect obsolete versions and remove them from the local storage (e.g., storage devices 414 of FIG. 4), so that only the most recent version (e.g., the valid version) of the data may be kept. As previously discussed, this garbage collection process (e.g., compaction process) performed on the local storage can cause significant write amplifications.

To reduce the write amplifications associated with the garbage collection process in the data storage system, the system can avoid conducting a full-scale garbage collection or compaction in the local storage. Instead, the obsolete records can be marked as records to delete. For example, as shown in FIG. 5, there are four obsolete records in the local storage, namely one version of data set 0 and three versions of data set 2. Instead of removing these obsolete records through compactions or garbage collections right away, the system can mark them, such as marking them as records to delete. In some embodiments, the system can append delete operations on the obsolete records into a translation layer (e.g., FTL 305 of FIG. 3). In some embodiments, data is stored as a key-value store. As a result, the delete operation can reference the key for the data (e.g., delete (key)), and the system can append operation “delete (data)” into the translation layer.

In some embodiments, the translation layer is in charge of conducting garbage collections in the host-managed drives. For example, when the FTL performs garbage collection operations on SSDs, the garbage collection operations can access the marked obsolete versions of the data and delete them. As shown in FIG. 5, the obsolete versions of data sets 0 and 2 can be marked, and the markings can be collected (e.g., as delete operations on the keys). As a result, the garbage collection operations initiated by the FTL can delete the obsolete versions of data sets 0 and 2. Therefore, after the operation of garbage collection on the SSDs, the valid versions of data sets 0-3 are stored in the SSDs.

In some embodiments, the markings (e.g., delete operations) can be appended after the data in the local storage. Therefore, when the translation layer performs garbage collections, the translation layer can easily locate the marked obsolete records, and remove the obsolete records accordingly.

In some embodiments, data that are created or updated in a similar timeframe may be updated again in a similar timeframe. Therefore, if data with similar timeframes can be stored close to each other (e.g., on a same data block in the SSDs), due to the similar timeframes of future update operations, the garbage collection operation can be timed at the similar timeframes, hence increasing the efficiency of garbage collections and reducing overall write amplification. Therefore, in some embodiments, the translation layer can access metadata for the data block. The metadata can include information such as timestamps for the data block. As a result, the FTL can access information such as the creation time of data blocks. When conducting garbage collection, the FTL can group data blocks with similar timestamps (e.g., creation time) together, and append the grouped data blocks into SSDs.

In some embodiments, the translation layer can initiate garbage collections systematically. For example, the marked records can be cleaned up periodically while being stored into the SSDs. The frequency of performing the garbage collections can be adjusted to better optimize the efficiency of utilizing storage space in SSDs. In some embodiments, the frequency of performing the garbage collection can depend on the markings of the obsolete records or the timestamps of the markings. For example, in some embodiments, the system can determine the frequency of data updates on a particular data. Using data storage system 500 of FIG. 5 as an example, the system can determine that in a given time period, data set 0 is updated once, and data set 2 is updated three times. Moreover, data set 1 and data set 3 is not updated. As a result, the FTL can choose to store data set 0 and data set 2 in different data blocks. Moreover, data set 1 and data set 3 can be stored in a data block that is different from the data blocks storing data set 0 and data set 2. Therefore, the FTL can conduct periodic garbage collection operations on the different data blocks under different frequencies in a systematic fashion.

According to data storage system 500 shown in FIG. 5, in some embodiments, the garbage collection operations on local storage is no longer needed for the system. Instead, the system can simply mark the obsolete records for deletion. Without a need to conduct full scale garbage collections on the local storage, data storage system 500 can reduce write amplification significantly, and improve the efficiency of performing garbage collections on storage formats that rely on sequential writes (e.g., appending update operations).

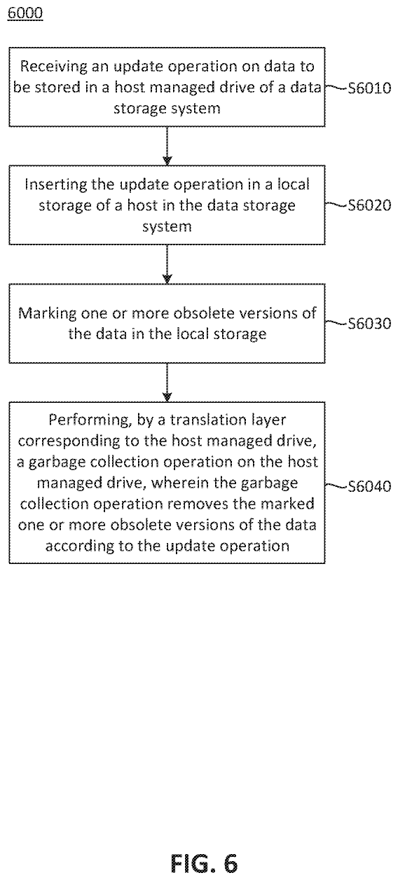

Embodiments of the present disclosure further provide a method for combined garbage collections in a distributed data storage system. FIG. 6 is a flowchart of an example method for performing combined garbage collections, according to some embodiments of the present disclosure. It is appreciated that method 6000 of FIG. 6 can be executed on data storage system 500 shown in FIG. 5.

In step S6010, an update operation on data to be stored in a host-managed drive is received in a data storage system. In some embodiments, the data storage system is a distributed data storage system. In some embodiments, the update operation can render one or more older versions of the data stored in a local storage (e.g., storage 414 of FIG. 4) obsolete. In some embodiments, the local storage is a part of a host (e.g., host 301 of FIG. 3 or server 410 of FIG. 4). In some embodiments, the data is stored as key-value stores or rooted-tree structures.

In step S6020, the update operation is inserted into the local storage. In some embodiments, the update operation (e.g., modifying operation, deleting operation, etc.) may not be performed on the copy of the data stored in the local storage. Instead, the operation is inserted into the storage as a new version. In some embodiments, the update operation is appended into the local storage. In some embodiments, the update operation can include metadata, which can include timestamps of the update operation.

In step S6030, one or more obsolete versions of the data are marked in the local storage. In some embodiments, the one or more obsolete versions are marked as records to be deleted. For example, as shown in FIG. 5, a delete operation can be inserted or appended in the local storage. In some embodiments, data is stored as key-value stores. As a result, the delete operation can reference the key for the data (e.g., delete (key)), and the system can append operation “delete (data)” into the FTL.

In step S6040, a garbage collection operation is performed on the host-managed drive by a translation layer corresponding to the SSD. The garbage collection operation can remove the one or more obsolete versions of data that have been marked in step S6030. In some embodiments, the host-managed drive is an SSD, and the translation layer is an FTL for the SSD.

In some embodiments, the garbage collection operation in step S6040 can access the marked obsolete versions of the data and remove them. For example, as shown in FIG. 5, the obsolete versions of data sets 0 and 2 can be marked, and the markings can be collected (e.g., as delete operations on the keys). As a result, the garbage collection operations initiated by the FTL can delete the obsolete versions of data sets 0 and 2. Therefore, after the operation of garbage collection on the SSDs, the valid versions of data sets 0-3 are stored in the SSDs. In some embodiments, the markings (e.g., delete operations) can be appended after the data in the local storage. As a result, when the FTL performs garbage collections, the FTL can easily locate the marked obsolete records, and remove the obsolete records accordingly.

In some embodiments, the garbage collection operation in step S6040 can be timed to increase the efficiency of garbage collections and reducing overall write amplification. For example, in some embodiments, the FTL can access metadata for the data chunk or data block. The metadata can include information such as timestamps for the data chunk or the data block. As a result, the FTL can access information such as the creation time. When conducting garbage collection, the FTL can group data chunks or data blocks with similar timestamps (e.g., creation time) together, and append the grouped data chunks or data blocks into SSDs.

In some embodiments, in step S6040, the FTL can initiate garbage collections systematically. For example, the marked records can be cleaned up periodically while being stored into the SSDs. The frequency of performing the garbage collections can be adjusted to better optimize the efficiency of utilizing storage space in SSDs. In some embodiments, the frequency of performing the garbage collection can depend on the markings of the obsolete records or the timestamps of the markings. For example, in some embodiments, the system can determine the frequency of data updates on a particular data. Using data storage system 500 of FIG. 5 as an example, the system can determine that in a given time period, data set 0 is updated once, and data set 2 is updated three times. Moreover, data set 1 and data set 3 is not updated. As a result, the FTL can choose to store data set 0 and data set 2 in different data blocks. Moreover, data set 1 and data set 3 can be stored in a data block that is different from the data blocks storing data set 0 and data set 2. Therefore, the FTL can conduct garbage collection on the different data blocks under different frequencies in a systematic fashion.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, SSD, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The host system, operating system, file system, and other functional units described in this disclosure can be implemented by hardware, or software, or a combination of hardware and software. One of ordinary skill in the art will also understand that multiple ones of the above described functional units may be combined as one functional unit, and each of the above described functional units may be further divided into a plurality of functional sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

The embodiments may further be described using the following clauses:

1. A method, comprising:

receiving an update operation on data to be stored in a host-managed drive in a data storage system;

inserting the update operation in a local storage of a host of the data storage system;

marking one or more obsolete versions of the data in the local storage; and

performing, by a translation layer corresponding to the host-managed drive, a garbage collection operation on the host-managed drive, wherein the garbage collection operation removes the one or more obsolete versions of the data marked in the local storage according to the update operation, and the translation layer comprises address mapping information between the host and the host-managed drive.

2. The method of clause 1, wherein:

the host-managed drive is a solid-state drive; and

the translation layer is a flash translation layer located in the host.

3. The method of clause 1 or 2, wherein:

the data is stored as key-value stores; and

marking one or more obsolete versions of the data in the local storage comprises:
inserting a delete operation on the one or more obsolete versions of the data in the local storage, wherein the delete operation comprises one or more keys corresponding to the one or more obsolete versions of the data.

4. The method of clause 3, wherein inserting the delete operation on the one or more obsolete versions of the data in the local storage comprises:

appending the delete operation after the data in the local storage.

5. The method of any one of clauses 2-4, wherein the data is stored in rooted tree structures.

6. The method of any one of clauses 1-5, wherein:

the update operation comprises metadata including timestamps of the update operation; and

performing, by the translation layer corresponding to the host-managed drive, the garbage collection operation on the host-managed drive comprises:
performing, by the translation layer, the garbage collection operation systematically on the host-managed drive, wherein a frequency of performing the garbage collection operation is associated with the timestamps of the update operation.

7. The method of any one of clauses 1-6, wherein the data storage system is a distributed data storage system.

8. A non-transitory computer readable medium that stores a set of instructions that is executable by at least one processor of a computer system to cause the computer system to perform a method, the method comprising:

receiving an update operation on data to be stored in a host-managed drive in a data storage system;

inserting the update operation in a local storage of a host of the data storage system;

marking one or more obsolete versions of the data in the local storage; and

performing, by a translation layer corresponding to the host-managed drive, a garbage collection operation on the host-managed drive, wherein the garbage collection operation removes the one or more obsolete versions of the data marked in the local storage according to the update operation, and the translation layer comprises address mapping information between the host and the host-managed drive.

9. The non-transitory computer readable medium of clause 8, wherein:

the host-managed drive is a solid-state drive; and

the translation layer is a flash translation layer located in the host.

10. The non-transitory computer readable medium of clause 8 or 9, wherein:

the data is stored as key-value stores; and

the set of instructions is executable by the at least one processor of the computer system to cause the computer system to further perform:
inserting a delete operation on the one or more obsolete versions of the data in the local storage, wherein the delete operation comprises one or more keys corresponding to the one or more obsolete versions of the data.

11. The non-transitory computer readable medium of clause 10, wherein the set of instructions is executable by the at least one processor of the computer system to cause the computer system to further perform:

appending the delete operation after the data in the local storage.

12. The non-transitory computer readable medium of any one of clauses 9-11, wherein the data is stored in rooted tree structures.

13. The non-transitory computer readable medium of any one of clauses 8-12, wherein:

the update operation comprises metadata including timestamps of the update operation; and

the set of instructions is executable by the at least one processor of the computer system to cause the computer system to further perform:
performing, by the translation layer, the garbage collection operation systematically on the host-managed drive, wherein a frequency of performing the garbage collection operation is associated with the timestamps of the update operation.

14. The non-transitory computer readable medium of any one of clauses 8-13, wherein the data storage system is a distributed data storage system.

15. A system, comprising:

a memory storing a set of instructions; and

one or more processors configured to execute the set of instructions to cause the system to perform:
receiving an update operation on data to be stored in a host-managed drive in a data storage system;

inserting the update operation in a local storage of a host of the data storage system;

marking one or more obsolete versions of the data in the local storage; and

performing, by a translation layer corresponding to the host-managed drive, a garbage collection operation on the host-managed drive, wherein the garbage collection operation removes the one or more obsolete versions of the data marked in the local storage according to the update operation, and the translation layer comprises address mapping information between the host and the host-managed drive.

16. The system of clause 15, wherein:

the host-managed drive is a solid-state drive; and

the translation layer is a flash translation layer located in the host.

17. The system of clause 15 or 16, wherein:

the data is stored as key-value stores; and

the one or more processors are further configured to execute the set of instructions to cause the system to perform:
inserting a delete operation on the one or more obsolete versions of the data in the local storage, wherein the delete operation comprises one or more keys corresponding to the one or more obsolete versions of the data.

18. The system of clause 17, wherein:

the data storage system is a distributed data storage system; and

the one or more processors are further configured to execute the set of instructions to cause the system to perform:
appending the delete operation after the data in the local storage.

19. The system of any one of clauses 16-18, wherein the data is stored in rooted tree structures.

20. The system of any one of clauses 15-19, wherein:

the update operation comprises metadata including timestamps of the update operation; and

the one or more processors are further configured to execute the set of instructions to cause the system to perform:
performing, by the translation layer, the garbage collection operation systematically on the host-managed drive, wherein a frequency of performing the garbage collection operation is associated with the timestamps of the update operation.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method, comprising:
receiving an update operation on data to be stored in a host-managed drive in a data storage system;
inserting the update operation in a local storage of a host of the data storage system;
marking one or more obsolete versions of the data in the local storage; and
performing, by a translation layer corresponding to the host-managed drive, a garbage collection operation on the host-managed drive, wherein the garbage collection operation removes the one or more obsolete versions of the data marked in the local storage according to the update operation, and the translation layer comprises address mapping information between the host and the host-managed drive.

2. The method of claim 1, wherein:
the host-managed drive is a solid-state drive; and
the translation layer is a flash translation layer located in the host.

3. The method of claim 1, wherein:
the data is stored as key-value stores; and
marking one or more obsolete versions of the data in the local storage comprises:
inserting a delete operation on the one or more obsolete versions of the data in the local storage, wherein the delete operation comprises one or more keys corresponding to the one or more obsolete versions of the data.

4. The method of claim 3, wherein inserting the delete operation on the one or more obsolete versions of the data in the local storage comprises:
appending the delete operation after the data in the local storage.

5. The method of claim 2, wherein the data is stored in rooted tree structures.

6. The method of claim 1, wherein:
the update operation comprises metadata including timestamps of the update operation; and
performing, by the translation layer corresponding to the host-managed drive, the garbage collection operation on the host-managed drive comprises:
performing, by the translation layer, the garbage collection operation systematically on the host-managed drive, wherein a frequency of performing the garbage collection operation is associated with the timestamps of the update operation.

7. The method of claim 1, wherein the data storage system is a distributed data storage system.

8. A non-transitory computer readable medium that stores a set of instructions that is executable by at least one processor of a computer system to cause the computer system to perform a method, the method comprising:
receiving an update operation on data to be stored in a host-managed drive in a data storage system;
inserting the update operation in a local storage of a host of the data storage system;
marking one or more obsolete versions of the data in the local storage; and
performing, by a translation layer corresponding to the host-managed drive, a garbage collection operation on the host-managed drive, wherein the garbage collection operation removes the one or more obsolete versions of the data marked in the local storage according to the update operation, and the translation layer comprises address mapping information between the host and the host-managed drive.

9. The non-transitory computer readable medium of claim 8, wherein:
the host-managed drive is a solid-state drive; and
the translation layer is a flash translation layer located in the host.

10. The non-transitory computer readable medium of claim 8, wherein:
the data is stored as key-value stores; and
the set of instructions is executable by the at least one processor of the computer system to cause the computer system to further perform:
inserting a delete operation on the one or more obsolete versions of the data in the local storage, wherein the delete operation comprises one or more keys corresponding to the one or more obsolete versions of the data.

11. The non-transitory computer readable medium of claim 10, wherein the set of instructions is executable by the at least one processor of the computer system to cause the computer system to further perform:
appending the delete operation after the data in the local storage.

12. The non-transitory computer readable medium of claim 9, wherein the data is stored in rooted tree structures.

13. The non-transitory computer readable medium of claim 8, wherein:
the update operation comprises metadata including timestamps of the update operation; and
the set of instructions is executable by the at least one processor of the computer system to cause the computer system to further perform:
performing, by the translation layer, the garbage collection operation systematically on the host-managed drive, wherein a frequency of performing the garbage collection operation is associated with the timestamps of the update operation.

14. The non-transitory computer readable medium of claim 8, wherein the data storage system is a distributed data storage system.

15. A system, comprising:
a memory storing a set of instructions; and
one or more processors configured to execute the set of instructions to cause the system to perform:
receiving an update operation on data to be stored in a host-managed drive in a data storage system;
inserting the update operation in a local storage of a host of the data storage system;
marking one or more obsolete versions of the data in the local storage; and
performing, by a translation layer corresponding to the host-managed drive, a garbage collection operation on the host-managed drive, wherein the garbage collection operation removes the one or more obsolete versions of the data marked in the local storage according to the update operation, and the translation layer comprises address mapping information between the host and the host-managed drive.

16. The system of claim 15, wherein:
the host-managed drive is a solid-state drive; and
the translation layer is a flash translation layer located in the host.

17. The system of claim 15, wherein:
the data is stored as key-value stores; and
the one or more processors are further configured to execute the set of instructions to cause the system to perform:
inserting a delete operation on the one or more obsolete versions of the data in the local storage, wherein the delete operation comprises one or more keys corresponding to the one or more obsolete versions of the data.

18. The system of claim 17, wherein:
the data storage system is a distributed data storage system; and
the one or more processors are further configured to execute the set of instructions to cause the system to perform:
appending the delete operation after the data in the local storage.

19. The system of claim 16, wherein the data is stored in rooted tree structures.

20. The system of claim 15, wherein:
the update operation comprises metadata including timestamps of the update operation; and
the one or more processors are further configured to execute the set of instructions to cause the system to perform:
performing, by the translation layer, the garbage collection operation systematically on the host-managed drive, wherein a frequency of performing the garbage collection operation is associated with the timestamps of the update operation.
